(19) United States
(12) Patent Application Publication
(10) Pub. No.: US 2008/0152992 A1
(43) Pub. Date: Jun. 26, 2008

(54) CONSTITUENT MEMBER FOR MEMBRANE ELECTRODE ASSEMBLY, MEMBRANE ELECTRODE ASSEMBLY, POLYMER ELECTROLYTE FUEL CELL, AND METHOD FOR PRODUCING CONSTITUENT MEMBER AND MEMBRANE ELECTRODE ASSEMBLY

(75) Inventors: Keiko Abe, Kawasaki-shi (JP); Motokazu Kobayashi, Yokohama-shi (JP); Makoto Kubota, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/950,759

(22) Filed: Dec. 5, 2007

(30) Foreign Application Priority Data
Dec. 20, 2006 (JP) 2006-343046

(51) Int. Cl. H01M 4/86; H01M 8/02; B32B 37/00

(52) U.S. Cl. 429/40; 429/12; 156/60

(57) ABSTRACT

A constituent member for a membrane electrode assembly for use in a polymer electrolyte fuel cell is provided. This constituent member includes an insulating porous membrane, two conductive porous membranes, and bonding portions between the insulating porous membrane and the conductive porous membranes, wherein the two conductive porous membranes are not detached from the insulating porous membrane or are damaged when detached from the insulating porous membrane, and wherein the constituent member has an air resistance of 10 s/100 mL·645 mm² to 200 s/100 mL·645 mm².

### BACKGROUND OF THE INVENTION

1. Field of the Invention

The present invention relates to a constituent member for a membrane electrode assembly used in a polymer electrolyte fuel cell, a membrane electrode assembly, a polymer electrolyte fuel cell, and a method for producing the constituent member and the membrane electrode assembly.

2. Description of the Related Art

In membrane electrode assemblies that include Nafion® electrolyte membranes, Nafion® solutions having the same constituents as Nafion® membranes are generally used as adhesives for bonding electrolyte membranes to diffusion layers. In such cases, even when low-adhesion-strength adhesives mainly composed of proton conductors are used, satisfactory bonds between electrolyte membranes and diffusion layers can be maintained because adhesives have the same constituents as the electrolyte membranes.

In the case where insulating porous membranes are used as auxiliary membranes in order to increase the mechanical strength of electrolyte membranes, when adhesives mainly composed of proton conductors, such as Nafion® solutions, are used, adhesion between electrolyte membranes and diffusion layers is disadvantageously insufficient because of poor adhesion between adhesives and insulating porous membranes.

Japanese Patent Laid-Open No. 2004-247152 discloses a method for forming a membrane electrode assembly by arranging a polymer electrolyte membrane between gas diffusion electrodes serving as diffusion layers and performing hot-pressing. However, such a method disadvantageously results in insufficient adhesion.

### SUMMARY OF THE INVENTION

The present invention provides a constituent member of a membrane electrode assembly that maintains a satisfactory contact between an electrolyte membrane and a catalyst and maintains properties of the electrolyte membrane by using an insulating porous membrane and also provides a method for producing the constituent member. Furthermore, the present invention provides a membrane electrode assembly, including the constituent member, which strikes a balance between strength and power generation characteristics, a method for producing the membrane electrode assembly, and a polymer electrolyte fuel cell including the membrane electrode assembly.

According to an aspect of the present invention, a constituent member for a membrane electrode assembly used in a polymer electrolyte fuel cell includes an insulating porous membrane, two conductive porous membranes, and bonding portions between the insulating porous membrane and the conductive porous membranes, the insulating porous membrane being arranged between the two conductive porous membranes, and the two conductive porous membranes being opposite each other.

In a cross-cut adhesion test, according to JIS K 5600-5-6, the two conductive porous membranes are not detached from the insulating porous membrane or are damaged when detached from the insulating porous membrane.

Also, the constituent member in accordance with this aspect of the present invention has an air resistance of 10 s/100 mL·645 mm² to 200 s/100 mL·645 mm².

The bonding portions can be partially present between the insulating porous membrane and the conductive porous membranes, each bonding portion has an insulating material content of 40% or more, and the insulating material content is the highest component content among component contents in each bonding portion.

The bonding portions can be composed of a cured thermosetting resin.

The insulating porous membrane and the bonding portions can be composed of polyimide, and the conductive porous membranes can be composed of conductive carbon.

A membrane electrode assembly used in a polymer electrolyte fuel cell can include a constituent member described above, an electrolyte component present in pores of the insulating porous membrane, and a catalyst present in pores of the conductive porous membranes.

A polymer electrolyte fuel cell can include the membrane electrode assembly described above.

According to another aspect of the present invention, a method for producing a constituent member for a membrane electrode assembly used in a polymer electrolyte fuel cell can include the successive steps of:

applying an adhesive to surfaces of an insulating porous membrane or to surfaces of two conductive porous membranes;

bonding the insulating porous membrane to the two conductive porous membranes; and

curing the adhesive applied to form bonding portions,

wherein the insulating porous membrane is arranged between the two conductive porous membranes, the conductive porous membranes being opposite each other,

wherein in a cross-cut adhesion test according to JIS K 5600-5-6, the two conductive porous membranes are not detached from the insulating porous membrane or are damaged when detached from the insulating porous membrane, and

wherein the constituent member has an air resistance of 10 s/100 mL·645 mm² to 200 s/100 mL·645 mm².

A method for producing a membrane electrode assembly used in a polymer electrolyte fuel cell can include:

forming a constituent member for a membrane electrode assembly used in a polymer electrolyte fuel cell, the constituent member including an insulating porous membrane, two conductive porous membranes, and bonding portions between the insulating porous membrane and the conductive porous membranes,

charging an electrolyte component into the insulating porous membrane; and

charging a catalyst into each of the two conductive porous membranes,

wherein the step of forming the constituent member is performed by the method outlined above.

Each of the conductive porous membranes can have an air resistance of 10 s/100 mL·645 mm² or less.

The adhesive can be composed of a thermosetting resin. The step of curing the adhesive can include a substep of applying heat.

Further features of the present invention will become apparent from the following description of exemplary embodiments with reference to the attached drawings.

### BRIEF DESCRIPTION OF THE DRAWINGS

FIG. 1 is a cross-sectional view of a constituent member of a membrane electrode assembly for a polymer electrolyte fuel cell according to an embodiment of the present invention.

FIGS. 2A and 2B are projection drawings of an insulating porous membrane and bonding portions according to an embodiment of the present invention.

FIG. 3 is a cross-sectional view of a membrane electrode assembly for a polymer electrolyte fuel cell according to an embodiment of the present invention.

FIG. 4 is a cross-sectional view of a constituent member in which bonding portions are formed on overall contact portions between an insulating porous membrane and conductive porous membranes.

FIG. 5 is a cross-sectional view of a polymer electrolyte fuel cell according to an embodiment of the present invention.

### DESCRIPTION OF THE EMBODIMENTS

Embodiments of the present invention will be described in detail below.

First, a constituent member for a membrane electrode assembly will be described.

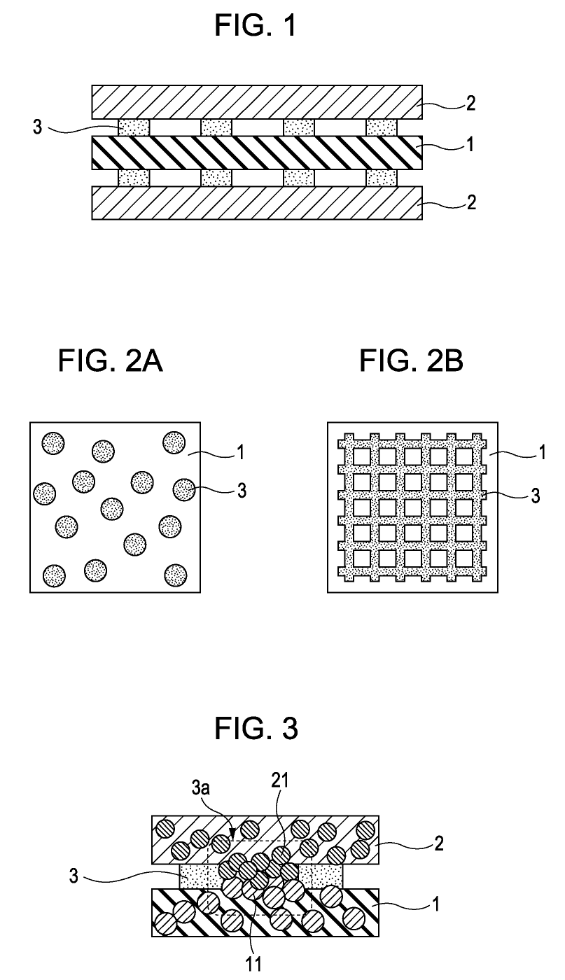

FIG. 1 is a cross-sectional view of a constituent member of a membrane electrode assembly according to an embodiment of the present invention, viewed in a direction parallel to the proton conduction direction.

The constituent member that can be used in the membrane electrode assembly of the present invention includes an insulating porous membrane 1, conductive porous membranes 2, and bonding portions 3. The insulating porous membrane 1 is fixed between the conductive porous membranes 2 by the bonding portions 3 so as to face the conductive porous membranes 2.

The function of the insulating porous membrane 1 is to hold inside an electrolyte component. To that end, the membrane is electrically insulating and contains numerous micropores. These micropores are not independently present, and can appropriately communicate with each other to form passages extending from one surface to the opposite surface. This is because the passages facilitate permeation of a gas or a liquid across the membrane.

The thickness of the insulating porous membrane 1 and the size of the micropores are not particularly limited but may be selected on the basis of the material, the target strength of the electrolyte membrane, target characteristics of the polymer electrolyte fuel cell, and the like. The insulating porous membrane 1 can have a thickness of 15 to 150 μm based on the general use of polymer electrolyte fuel cells. When the insulating porous membrane 1 has a thickness of less than 15 μm, the mechanical strength of the membrane may be reduced. A thickness exceeding 150 μm may reduce electrical efficiency due to an increase in the proton travel distance.

The insulating porous membrane 1 is composed of a water-insoluble polymer material. Examples of the polymer material include various resin materials, such as polyimide resins (e.g., UPILEX PT, manufactured by Ube Industries, Ltd.), polytetrafluoroethylene resins (e.g., a porous PTFE membrane, manufactured by Nitto Denko Corporation), polyamide resins, polyimide-amide resins, and polyolefin resins. The term “polyimide resins” includes resins composed of a polyimide or derivatives of a polyimide. Polyamide derivatives are defined as polymers each having a polyamide as its main skeleton and in which side-chain hydrogen atoms of the polyamide are substituted. Examples of the polyamide derivatives include polymers produced from ethylenediamine and lauric acid; polymers produced from diethylenetriamine and stearic acid; and polymers produced from triethylenetetramine and oleic acid. The same is true of the other resins. In the case where methanol is selected as fuel, the insulating porous membrane 1 is selected from materials that do not substantially swell with methanol or water. Among the materials, polyimide materials are preferred from the viewpoint of insolubility in methanol and water, physical strength, and chemical stability.

The conductive porous membranes 2 function as diffusion layers that efficiently and uniformly feed hydrogen, reformed hydrogen, methanol, or dimethyl ether as fuel and air or oxygen as an oxidizer into a catalytic layer. These conductive porous membranes 2 are in contact with the catalytic layer to smoothly pass electrons participating in a catalytic reaction. The conductive porous membranes are composed of a material mainly containing conductive carbon. In general, carbon paper, carbon cloth, and a carbon composite sheet and polytetrafluoroethylene may be used. Furthermore, conductive porous membranes subjected to a water repellent treatment by coating the surfaces and/or the inside of each of the conductive porous membranes with fluorocarbon paint may be used.

The bonding portions 3 are formed by curing an adhesive. Examples of the adhesive that may be used include thermosetting resins that are cured by heat, UV-curable resins that are cured by UV irradiation, and an adhesive that is cured by mixing two or more reagents. Curing may also be performed by combining two or more of the above-noted different types of materials. Thermosetting resins can strongly bond the membranes by heating. Examples of the thermosetting resins that can be used include polyimide compounds (e.g., polyimide varnish “U-Varnish” and an over coat material “UPICOAT” (registered trademark), manufactured by Ube Industries, Ltd.), silane compounds (e.g. a silane coupling agent, manufactured by Shin-Etsu Chemical Co., Ltd.), urethane resins, phenol resins, acrylic resins, epoxy resins, and unsaturated polyester resins. These resins may be used separately or in combination as a mixture. A thermosetting resin mainly composed (40% or more) of an insulating resin and containing a metal filler having electron conductivity may be used, the content of the insulating resin being the highest component content among component contents in the thermosetting resin. A material constituting the adhesive can be identical to the material constituting the insulating porous membrane or a derivative of the material constituting the insulating porous membrane. For example, in the case where the insulating porous membrane is composed of a polyimide resin, the adhesive can be composed of a polyimide compound.

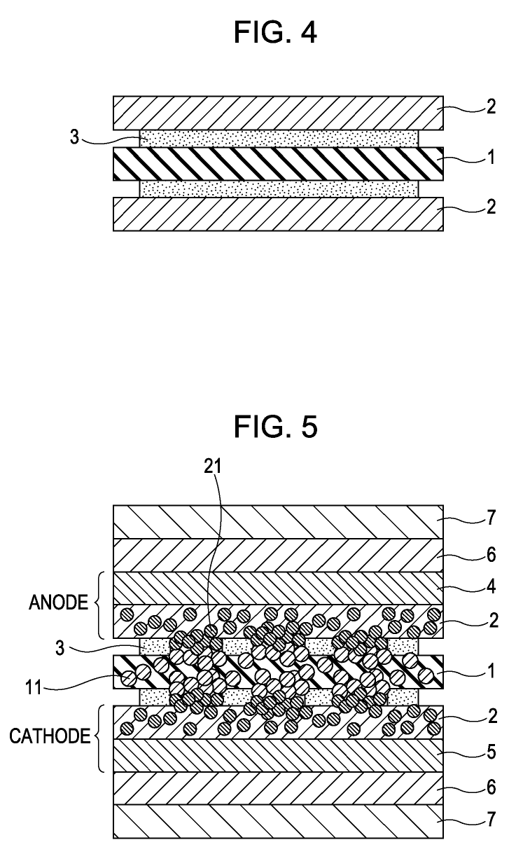

In general, these adhesives having strong adhesive power are mainly composed (40% or more) of insulating materials and do not have proton conductivity. Thus, it is necessary to partially form the bonding portions by applying an adhesive as shown in FIG. 1 in lieu of forming the bonding portions on the entire contact portion by applying the adhesive as shown in FIG. 4. This is because the application of the adhesive that does not have proton conductivity to the entire contact portions between the insulating porous membrane and the conductive porous membranes blocks the channels for proton conduction. FIG. 4 is a cross-sectional view of the constituent member of the membrane electrode assembly when the adhesive is applied to the overall contact portions between the insulating porous membrane 1 and the conductive porous membranes 2, viewed in a direction parallel to the proton conduction direction.

A single bonding portion may be formed on one conductive porous membrane. Alternatively, a plurality of bonding portions can be formed on one conductive porous membrane. The use of the plurality of bonding portions results in strong adhesion even if each of the bonding portions has a small area. As shown in FIG. 2A, the plurality of bonding portions can have an island structure in which the plurality of bonding portions are present in the vicinity of the center of the insulating porous membrane. Alternatively, as shown in FIG. 2B, a network structure can be used. FIGS. 2A and 2B are projection drawings of the insulating porous membrane and the bonding portions in a direction parallel to the proton conduction direction from a contact face between the insulating porous membrane and one of the conductive porous membranes. As used herein, the case where a plurality of non-bonded portions completely separated by the bonding portions are present is defined as the case where a plurality of fixed portions are present. The area of the bonding portions can be in the range from 20% to 80% of the area of the contact face between the insulating porous membrane and one of the conductive porous membranes, assuming that the contact portions between the insulating porous membrane and the conductive porous membranes are flat surfaces.

The constituent member for the membrane electrode assembly of the present invention is a member for a membrane electrode assembly used in a polymer electrolyte fuel cell, the insulating porous membrane being arranged between the two conductive porous membranes, and the conductive porous membranes being opposite each other, wherein in a cross-cut adhesion test according to JIS K 5600-5-6, the two conductive porous membranes are not detached from the insulating porous membrane or are damaged when detached from the insulating porous membrane, and wherein the constituent member has an air resistance of 10 s/100 mL·645 mm² to 200 s/100 mL·645 mm². “JIS K 5600-5-6 test” is a test for evaluating adhesion by a cross-cut method used to test paints. In the present invention, a cross-cut adhesion test according to JIS K 5600-5-6 is performed. As described below, in the cross-cut adhesion test according to JIS K 5600-5-6, two conductive porous membranes are not detached from the insulating porous membrane or are damaged when detached from the insulating porous membrane, which may be referred to as the case where the conductive porous membranes are fixed to the insulating porous membrane.

A specific method of performing the cross-cut adhesion test will be described below. Eleven cuts spaced at intervals of 1 mm in each of the longitudinal and lateral directions are made in a conductive porous membrane as a specimen with a blade of a utility knife to form a grid pattern divided into 100 sections. Immediately after a tape having a width of 12 mm specified by JIS Z 1522 is attached to the conductive porous membrane by strongly pressing the tape against the membrane, the tape is peeled off in the direction of the normal to the conductive porous membrane. No detachment of the sections of the grid in the conductive porous membrane by visual observation is defined as 100/100. The phrase “no detachment” means that the number of sections detached in the above-described test is zero, i.e., 100/100. The phrase “detachment with resulting damage to the surface of the tape” means that when a section of the grid is detached in the above-described test, a part of the insulating porous membrane is detached and damaged simultaneously with the detachment of the section. In other words, the insulating porous membrane is strongly bonded to the conductive porous membrane.

The air resistance of the constituent member including the insulating porous membrane 1 and the conductive porous membranes 2 for use in a fuel cell needs to be 10 s/100 mL·645 mm² to 200 s/100 mL·645 mm². The air resistance is expressed as the time measured by the Gurley method (a method for measuring the time required for permeation of a 100 mL of air across a sheet of paper having an area of 645 mm² at a pressure of 2.3 cmHg). A lower air resistance indicates a state in which the membrane has a larger number of pores therein to facilitate permeation of a gas and a liquid.

When the constituent member has an air resistance of less than 10 s/100 mL·645 mm², the constituent member may have insufficient mechanical strength due to an excessively large space inside the constituent member. At an air resistance exceeding 200 s/100 mL·645 mm², the space inside the constituent member is small, thereby reducing the amount of the electrolyte component that can be charged into the insulating porous membrane, which likely reduces electrical efficiency. The use of an adhesive that has strong adhesion and does not have proton conductivity in order to secure the membranes disadvantageously reduces the channels for proton conduction between the conductive porous membranes and the insulating porous membrane. This results in a reduction in the contact area between a catalyst and an electrolyte component, thereby reducing the performance of a fuel cell.

The air resistance of the insulating porous membrane 1 need not be particularly specified. From the viewpoint of mechanical strength, as in the case of the constituent member, the insulating porous membrane 1 can have an air resistance of 10 s/100 mL·645 mm² to 200 s/100 mL·645 mm². The conductive porous membranes 2 can have an air resistance of 10 s/100 mL·645 mm² or less in order to minimize the inhibition of the permeability of the insulating porous membrane alone by the conductive porous membranes. The conductive porous membranes are fixed to both sides of the insulating porous membrane. Thus, if the conductive porous membranes have a high air resistance, i.e., if the space inside each conductive porous membrane is small, it may be difficult to charge a sufficient amount of a proton-conducting component into the insulating porous membrane.

A method for producing a constituent member for a membrane electrode assembly used in a polymer electrolyte fuel cell includes the successive steps of:

(1) applying an adhesive to surfaces of an insulating porous membrane or to surfaces of two conductive porous membranes;
(2) bonding the insulating porous membrane to the two conductive porous membranes; and
(3) curing the adhesive applied to form bonding portions,
(4) whereby the insulating porous membrane is arranged between the two conductive porous membranes, the conductive porous membranes being opposite each other, and wherein in a cross-cut adhesion test according to JIS K 5600-5-6, the two conductive porous membranes are not detached from the insulating porous membrane or are damaged when detached from the insulating porous membrane, and
(5) wherein the constituent member has an air resistance of 10 s/100 mL·645 mm² to 200 s/100 mL·645 mm².

In step (1), the adhesive may be applied to surfaces of the insulating porous membrane or to the surfaces of the two conductive porous membranes. The adhesive can be partially applied. The partial formation of the bonding portions satisfies both fixing and air resistance requirements even when a strong adhesive that does not have proton conductivity is used. The term “partially” means that the adhesive can be applied to only a part of the contact portions between the insulating porous membrane and the conductive porous membranes. As described above, assuming that the contact portions between the insulating porous membrane and the conductive porous membranes are flat surfaces, the adhesive can be applied such that the area of the bonding portions is in the range of 20% to 80% of the area of the contact portions. The insulating porous membrane, the conductive porous membranes, and the adhesive are the same as described above.

In step (2), the insulating porous membrane may be arranged so as to face the conductive porous membranes. These membranes need not be arranged at symmetric positions.

In step (3), the adhesive is cured by a curing method depending on the type of the adhesive that was used, thereby forming the bonding portions. Examples of the curing method include heating, pressurization, and UV irradiation. These methods may be employed in any combination.

With respect to one conductive porous membrane fixed to one surface of the insulating porous membrane and the other conductive porous membrane fixed to the other surface of the insulating porous membrane, the same type of conductive porous membranes may be used. Alternatively, different types of conductive porous membranes may be used.

As described above, the case where the insulating porous membrane is fixed to the conductive porous membranes is described by step (4). The air resistance of the conductive porous membranes and the constituent member for the membrane electrode assembly is in the range described in step (5) for the above-discussed reason.

Second, a membrane electrode assembly according to the present invention and a method for producing the membrane electrode assembly will be described below.

The membrane electrode assembly of the present invention used in a polymer electrolyte fuel cell includes the above-described constituent member in accordance with the present invention, the constituent member including the insulating porous membrane, the two conductive porous membranes, and the bonding portions between the insulating porous membrane and the conductive porous membranes, an electrolyte component present in pores of the insulating porous membrane, and a catalyst present in pores of the conductive porous membranes.

The constituent member of the membrane electrode assembly is the above-described constituent member in accordance with the present invention, thereby resulting in satisfactory contact between the electrolyte component present inside the insulating porous membrane and the catalyst. Specifically, as shown in FIG. 3, an electrolyte component 11 is in contact with a catalyst 21 to transmit protons in a region (region 3a in FIG. 3) other than the bonding portions 3 between the insulating porous membrane 1 and the conductive porous membranes 2. FIG. 3 is a cross-sectional view of the membrane electrode assembly including the insulating porous membrane 1, the conductive porous membranes 2, the catalyst 21, and the electrolyte component 11 in a direction parallel to the proton conduction direction.

The electrolyte component is composed of a compound having proton conductivity. As the compound having proton conductivity, a compound containing a functional group having proton conductivity can be used. Examples of the functional group having proton conductivity include a sulfonic group, a sulfinic acid group, a carboxylic group, phosphonic acid group, a phosphate group, a phosphinic acid group, and a boronic acid group. Among these groups, a sulfonic acid group and/or a phosphate group has a high proton conductivity.

Specifically, a compound having a molecular weight of 500 or less per sulfonic group or phosphonate group can be used, with the molecular weight per sulfonic group or phosphonate group being obtained by dividing the molecular weight of the compound by the number of the sulfonic groups or the phosphonate groups. Examples of a sulfonic group-containing compound include polymers of vinylsulfonic acid, allylsulfonic acid, styrenesulfonic acid, sulfobutyl methacrylates, sulfopropyl methacrylates, 2-acrylamido-2-methylpropanesulfonic acid, sulfobenzene methacrylates, and sulfobenzyl methacrylates. Polymers formed from monomers into which fluorine has been introduced may also be used. These polymers may include a single type of monomer. Alternatively, copolymers formed from different types of monomers may be used. An example of a phosphonate group-containing compound is a (meth)acrylate derivative polymer having a phosphate group in a side chain. The electrolyte component can be present completely inside the insulating porous membrane. A small amount of the electrolyte component may also be present in the conductive porous membranes.

The catalyst may be formed of a metal catalyst or a mixture of conductive carbon and a metal catalyst. The catalyst can be supported on the surface of conductive carbon. Examples of the metal catalyst include platinum-group metals, such as platinum, rhodium, ruthenium, iridium, palladium, and osmium, and alloys thereof. In particular, in the case where methanol is used as fuel, an alloy of platinum and ruthenium can be used. In the present invention, the catalyst is supported on surfaces of microstructures composed of conductive carbon. In the case where these catalyst-supporting microstructures are charged into the conductive porous membranes, conductive carbon is also regarded as a part of the catalyst. The metal catalyst can have a particle size of 1 nm to 10 nm. When the metal catalyst has a particle size of less than 1 nm, the catalyst particles have an excessively high activity, which makes handling these particles more difficult. When the metal catalyst has a particle size exceeding 10 nm, the activity may be reduced due to a reduction in the surface area of the catalyst.

The microstructures composed of conductive carbon and used for supporting the metal catalyst can be selected from carbon black, carbon fibers, graphite, carbon nanotubes, and the like. The microstructure composed of conductive carbon may be in the form of a particle, a column, a rectangular parallelepiped, or the like. When the microstructure is in the form of a particle, the microstructures can have an average particle size of 5 nm to 1,000 nm. Furthermore, the microstructures can have an average particle size of 10 nm to 100 nm. The microstructures composed of conductive carbon can have a relatively high specific surface area in order to support the catalyst. Specifically, the microstructures can have a specific surface area of 50 m²/g to 3,000 m²/g. Furthermore, the microstructures can have a specific surface area of 100 m²/g to 2,000 m²/g. The catalyst can be completely inside the conductive porous membranes. A small amount of the catalyst may also be present in the conductive porous membranes.

A method for producing a membrane electrode assembly according to the present invention includes:

(i) forming a constituent member of the membrane electrode assembly;
(ii) charging an electrolyte component into the inside of the insulating porous membrane; and
(iii) charging a catalyst into the inside of each of the two conductive porous membranes,

wherein step (i) of forming the constituent member of the membrane electrode assembly is performed by the above-described method for forming the constituent member for the membrane electrode assembly used in the polymer electrolyte fuel cell.

After the conductive porous membranes are fixed to the insulating porous membrane to form the constituent member of the membrane electrode assembly, the electrolyte component is charged into the insulating porous membrane, and the catalyst is charged into the conductive porous membranes, thereby forming the membrane electrode assembly. Thus, the membrane electrode assembly in which the insulating porous membrane is fixed to the conductive porous membranes can be produced without the deterioration of the electrolyte component and the catalyst.

In step (ii) of charging the electrolyte component, the electrolyte component is charged into the insulating porous membrane. To retain the electrolyte component may be charged into the insulating porous membrane in a polymerized state. Alternatively, a monomer or an oligomer serving as a precursor of the above-described compound having proton conductivity may be charged into the insulating porous membrane and then polymerized to form the electrolyte component. In this case, there is also included in the step of charging the electrolyte component.

Examples of a method for charging the electrolyte component or the precursor of the electrolyte component, such as the monomer, include coating and immersion. Examples of a method for polymerizing the precursor of the electrolyte component include thermal polymerization, photopolymerization, and electron beam polymerization. Among these methods, electron beam polymerization is preferably used. To facilitate the penetration of these compounds into the pores during coating or immersion, ultrasonic vibrations may be applied, and vacuum filtration or pressure filtration may be combined.

In the case where the precursor is charged into the insulating porous membrane and is then polymerized, the excess compound remaining on the surface or in the constituent member of the membrane electrode assembly can be removed by washing the constituent member. A washing method is not particularly limited. For effective washing, the constituent member may be immersed in a solvent that can dissolve the precursor of the electrolyte component.

In step (iii), the catalyst is charged into each of the two conductive porous membranes fixed to the surfaces of the insulating porous membrane. The catalyst may be simultaneously charged into the two conductive porous membranes. Alternatively, the catalyst may be charged into one of the two conductive porous membranes and then charged into the other. Examples of a method for charging the catalyst into the conductive porous membranes include a method for charging a paste containing a catalyst-supporting conductive material into the conductive porous membranes, and a method for directly providing the catalyst to the conductive porous membranes by sputtering or the like. The paste containing the catalyst-supporting conductive material may further contain an electrolyte material and an organic solvent in addition to the catalyst.

In the case where the paste containing the catalyst-supporting conductive material is used, the conductive porous membranes into which the paste containing the catalyst-supporting conductive material is charged can be sufficiently dried in an air or inert gas atmosphere until a solvent is evaporated at room or higher temperature. Steps (ii) and (iii) may be performed in a different order.

An oxygen diffusion layer 4, a fuel diffusion layer 5, separators 6, and collectors 7 are formed on the membrane electrode assembly to form a fuel cell as shown in FIG. 5. FIG. 5 is a cross-sectional view of a fuel cell according to an embodiment of the present invention in a direction parallel to the proton conduction direction. Fuel channels and oxygen channels formed in the separators are not shown.

### EXAMPLES

The present invention will be described in further detail below in the Examples. The present invention is not limited to these Examples.

### Example 1

### Method for Producing Constituent Member of Membrane Electrode Assembly

Polyimide varnish (U-Varnish, manufactured by Ube Industries, Ltd.) was applied to a plurality of positions including the middle of a surface of a sheet of carbon paper (TGP-H-060, thickness: 195 μm, size: 5 cm×5 cm, manufactured by Toray Industries, Inc.) at room temperature so as to form an island structure as shown in FIG. 2A. A polyimide porous membrane (UPILEX PT, thickness: 28 μm, size 7.5 cm×7.5 cm, manufactured by Ube Industries, Ltd.) was placed on the surface of the carbon paper, to which the polyimide varnish was applied in such a manner that the polyimide porous membrane was superimposed on the carbon paper. The resulting composite was dried at 120° C. for 1 hour in a hot air dryer to effect thermal curing. The polyimide varnish was completely cured to form bonding portions, thereby fixing the carbon paper to the polyimide porous membrane. Then a sheet of the same carbon paper as described above was fixed to the other surface of the polyimide porous membrane by the same method. Thereby, the constituent member for a membrane electrode assembly used in a polymer electrolyte fuel cell was obtained.

Observation of the section of the constituent member with a scanning electron microscope demonstrated that the polyimide porous membrane was partially bonded to the two sheets of carbon paper with the cured resin.

### Method for Producing Membrane Electrode Assembly

Equal weights of vinylsulfonic acid, methacryloyloxyethyl phosphate (P-1M, manufactured by Kyoeisha Chemical Co., Ltd.), and acrylonitrile were mixed in a vessel to form a monomer mixture having proton conductivity. The constituent member produced by the method for producing a constituent member for a membrane electrode assembly used in a polymer electrolyte fuel cell was immersed in the monomer mixture to charge the monomer materials into the inside the constituent member. Electron beam polymerization was performed at an acceleration voltage of 200 kV and a dose of 50 kGy to retain an electrolyte component inside the constituent member. The constituent member containing the electrolyte component was washed with a 5 wt % aqueous methanol solution to remove excess organic components remaining inside the constituent member.

Next, 1 g of carbon (manufactured by Tanaka Kikinzoku Kogyo K.K.) supporting a platinum-ruthenium catalyst (manufactured by Tanaka Kikinzoku Kogyo K.K.) and 5 g of a 5 wt % Nafion® solution (manufactured by Sigma-Aldrich Co.) were sufficiently mixed to form a paste containing a catalyst-supporting conductive material used for a fuel electrode. Furthermore, 1 g of carbon (manufactured by Tanaka Kikinzoku Kogyo K.K.) supporting a platinum catalyst (manufactured by Tanaka Kikinzoku Kogyo K.K.) and 5 g of a 5 wt % Nafion® solution (manufactured by Sigma-Aldrich Co.) were sufficiently mixed to form a paste containing a catalyst-supporting conductive material used for an air electrode. The paste containing the catalyst-supporting conductive material used for the fuel electrode was charged into one of the two sheets of carbon paper constituting the constituent member containing the electrolyte component. The paste was sufficiently dried to form a catalytic layer of the fuel electrode. The paste containing the catalyst-supporting conductive material used for the air electrode was similarly charged into the other carbon paper and dried to form a catalytic layer of the air electrode. Thereby, the membrane electrode assembly used in a polymer electrolyte fuel cell was obtained.

### Example 2

A constituent member for a membrane electrode assembly used in a polymer electrolyte fuel cell and a membrane electrode assembly were produced as in EXAMPLE 1, except that a silane coupling agent (KBE-9007, manufactured by Shin-Etsu Chemical Co., Ltd.) was used in place of the polyimide varnish (U-Varnish, manufactured by Ube Industries, Ltd.), and drying was performed at 100° C. for 1 hour.

### Example 3

A constituent member for a membrane electrode assembly used in a polymer electrolyte fuel cell and a membrane electrode assembly were produced as in EXAMPLE 1, except that a urethane resin (Urex, manufactured by Nihon Gosei Kako Co., Ltd.) was used in place of the polyimide varnish (U-Varnish, manufactured by Ube Industries, Ltd.), and drying was performed at 70° C. for 5 hours.

### Example 4

A constituent member for a membrane electrode assembly used in a polymer electrolyte fuel cell and a membrane electrode assembly were produced as in EXAMPLE 1, except that a phenol resin (PL-2243, manufactured by Gunei Chemical Industry Co., Ltd.) was used in place of the polyimide varnish (U-Varnish, manufactured by Ube Industries, Ltd.), and pressing was performed at a pressure of 100 kg/cm² at 120° C. for 10 minutes.

### Example 5

A constituent member for a membrane electrode assembly used in a polymer electrolyte fuel cell and a membrane electrode assembly were produced as in EXAMPLE 1, except that a PTFE membrane (manufactured by Advantech Toyo Co. Ltd.) was used in place of the polyimide porous membrane.

### Example 6

A constituent member for a membrane electrode assembly used in a polymer electrolyte fuel cell and a membrane electrode assembly were produced as in EXAMPLE 1, except that a carbon cloth (GF-20-31E, manufactured by Nippon Carbon Co., Ltd.) was used in place of the carbon paper.

### Example 7

A constituent member for a membrane electrode assembly used in a polymer electrolyte fuel cell and a membrane electrode assembly were produced as in EXAMPLE 1, except that the polyimide varnish was applied to a surface of the carbon paper so as to form a grid pattern as shown in FIG. 2B.

### Comparative Example 1

A constituent member for a membrane electrode assembly used in a polymer electrolyte fuel cell and a membrane electrode assembly were produced as in EXAMPLE 1, except that a Nafion® solution was used in place of the polyimide varnish (U-Varnish, manufactured by Ube Industries, Ltd.), the Nafion® solution was uniformly applied to an overall surface of each of the electrolyte membranes, and pressing was performed at a pressure of 100 kg/cm² at 120° C. for 10 minutes.

### Comparative Example 2

A constituent member for a membrane electrode assembly used in a polymer electrolyte fuel cell and a membrane electrode assembly were produced as in EXAMPLE 1, except that the polyimide varnish (U-Varnish, manufactured by Ube Industries, Ltd.) was applied to the entire two surfaces of the insulating porous membrane as shown in FIG. 4 instead of being applied so as to form the island structure as shown in FIG. 2A.

### Evaluation

### Air Resistance Test

The air resistance of the conductive porous membranes and the constituent members for the membrane electrode assemblies produced in EXAMPLES 1 to 7 and COMPARATIVE EXAMPLES 1 and 2 were measured by the Gurley method with a Gurley type densometer (manufactured by Toyo Seiki Seisaku-sho, Ltd.). Table 1 shows the results.

TABLE 1

| | Air resistance | |
|---|---|---|
| | (s/100 mL · 645 mm²) | |
| | Conductive porous | Constituent |
| Example | membrane | member |
| EXAMPLE 1 | <2 | 129.5 |
| EXAMPLE 2 | <2 | 137.1 |
| EXAMPLE 3 | <2 | 155.2 |
| EXAMPLE 4 | <2 | 142.8 |
| EXAMPLE 5 | <2 | 12.1 |
| EXAMPLE 6 | <2 | 170.4 |
| EXAMPLE 7 | <2 | 199.2 |
| COMPARATIVE EXAMPLE 1 | <2 | 212.5 |
| COMPARATIVE EXAMPLE 2 | <2 | Impermeable |

Each of the carbon paper and the carbon cloth used as the conductive porous membranes were highly porous and had an extremely high gas permeability rate. Thus, air resistance was at an extremely low level, which was below the measurement limit of the apparatus. The constituent members for the membrane electrode assemblies produced with these conductive porous membranes in EXAMPLES 1 to 7 had an air resistance of 10 s/100 mL·645 mm² to 200 s/100 mL·645 mm² as show in Table 1. However, the constituent member produced by applying the Nafion® solution to the entire contact portions between the insulating porous membrane and the conductive porous membranes in COMPARATIVE EXAMPLE 1 had an air resistance exceeding 200 s/100 mL·645 mm². In COMPARATIVE EXAMPLE 2, in which the conductive porous membranes were fixed to the insulating porous membrane by applying the same resin as that in EXAMPLE 1 to the entire surface of each of the two sheets of the carbon paper, there was no air penetration and air resistance was not measured.

### Power Generation Test

Each of the resulting membrane electrode assemblies was mounted to a direct-methanol fuel cell test cell (EFC25-01DM, manufactured by ElectroChem, Inc.) to form a polymer electrolyte fuel cell. Then a 5% aqueous methanol solution as fuel and oxygen as an oxidizer were supplied while the temperature of the cell was maintained at 70° C. to obtain the current-voltage relationship. Table 2 shows terminal voltages at the start of the measurement and 72 hours later when power generation was performed at a current density of 30 mA/cm².

### Adhesion after Measurement

After the above-described output measurement with the resulting membrane electrode assemblies, the cells were dismantled. The adhesion between the electrolyte membrane and the conductive porous membranes of each membrane electrode assembly was evaluated by a cross-cut adhesion test according to JIS K 5600-5-6. The evaluation criteria were as follows:

### Good: the conductive porous membranes were not detached from the insulating porous membrane or were damaged when detached from the insulating porous membrane;

### Poor: the conductive porous membranes detached and were damaged.

### Table 2 shows the results.

TABLE 2

| | |
|---|---|
| Terminal voltage (V) | Adhesion |

| | At start of | 72 hours | after |
|---|---|---|---|
| Example | measurement | later | measurement |
| EXAMPLE 1 | 0.59 | 0.57 | Good |
| EXAMPLE 2 | 0.56 | 0.55 | Good |
| EXAMPLE 3 | 0.51 | 0.49 | Good |
| EXAMPLE 4 | 0.53 | 0.50 | Good |
| EXAMPLE 5 | 0.50 | 0.48 | Good |
| EXAMPLE 6 | 0.52 | 0.51 | Good |
| EXAMPLE 7 | 0.49 | 0.47 | Good |
| COMPARATIVE | 0.62 | 0.35 | Poor |
| EXAMPLE 1 | | | |
| COMPARATIVE | 0 | 0 | Good |
| EXAMPLE 2 | | | |

In each of EXAMPLES 1 to 7, the terminal voltage was stable. The cross-cut adhesion test was performed after the measurement. The electrolyte membranes and the conductive porous membranes did not detach from each other.

In COMPARATIVE EXAMPLE 1, the terminal voltage at the start of the measurement was higher than in the Examples. However, 72 hours later, the terminal voltage was significantly reduced. The cross-cut adhesion test was performed after the output measurement. All 100 sections of the conductive porous membrane were detached. This may be because although the contact area between the catalyst and the Nafion® solution was large at the start of the measurement because the Nafion® solution had proton conductivity, the insulating porous membrane detached from the conductive porous membranes with time due to low adhesion between the electrolyte component and the auxiliary membrane, thereby degrading power generation characteristics.

In COMPARATIVE EXAMPLE 2, the conductive porous membranes were fixed to the insulating porous membrane after the output measurement. Since the adhesive that did not have proton conductivity was applied to the entire contact portions between the conductive porous membranes and the insulating porous membrane, the catalyst was not in contact with the electrolyte component. Therefore, the cell did not generate electricity.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-343046, filed Dec. 20, 2006, which is hereby incorporated by reference herein in its entirety.

What is claimed is:

1. A constituent member for a membrane electrode assembly for use in a polymer electrolyte fuel cell, comprising:
an insulating porous membrane;
two conductive porous membranes; and
bonding portions between the insulating porous membrane and the conductive porous membranes, the insulating porous membrane being arranged between the two conductive porous membranes, and the two conductive porous membranes being opposite each other,
wherein in a cross-cut adhesion test according to JIS K 5600-5-6, the two conductive porous membranes are not detached from the insulating porous membrane or are damaged when detached from the insulating porous membrane, and
wherein the constituent member has an air resistance of 10 s/100 mL·645 mm² to 200 s/100 mL·645 mm².

2. The constituent member according to claim 1,
wherein each of the conductive porous membranes has an air resistance of 10 s/100 mL·645 mm² or less.

3. The constituent member according to claim 1,
wherein the bonding portions are partially present between the insulating porous membrane and the conductive porous membranes, each bonding portion has an insulating material content of 40% or more, and the insulating material content is the highest component content among component contents in each bonding portion.

4. The constituent member according to claim 3,
wherein the bonding portions are composed of a cured thermosetting resin.

5. The constituent member according to claim 1,
wherein the insulating porous membrane and the bonding portions are composed of a polyimide, and the conductive porous membranes are composed of conductive carbon.

6. A membrane electrode assembly for use in a polymer electrolyte fuel cell, comprising:
a constituent member according to claim 1;
an electrolyte component in pores of the insulating porous membrane; and
a catalyst in pores of the conductive porous membranes.

7. A polymer electrolyte fuel cell comprising the membrane electrode assembly according to claim 6.

8. A method for producing a constituent member for a membrane electrode assembly for use in a polymer electrolyte fuel cell, the method comprising successive steps of:
applying an adhesive to surfaces of an insulating porous membrane or to surfaces of two conductive porous membranes;
bonding the insulating porous membrane to the two conductive porous membranes; and
curing the adhesive applied to form bonding portions,
wherein the insulating porous membrane is arranged between the two conductive porous membranes, the conductive porous membranes being opposite each other,
wherein in a cross-cut adhesion test according to JIS K 5600-5-6, the two conductive porous membranes are not detached from the insulating porous membrane or are damaged when detached from the insulating porous membrane, and
wherein the constituent member has an air resistance of 10 s/100 mL·645 mm² to 200 s/100 mL·645 mm².

9. The method according to claim 8,
wherein each of the conductive porous membranes has an air resistance of 10 s/100 mL·645 mm² or less.

10. A method for producing a membrane electrode assembly for use in a polymer electrolyte fuel cell, the method comprising:
forming a constituent member
comprising an insulating porous membrane,
two conductive porous membranes, and
bonding portions between the insulating porous membrane and the conductive porous membranes according to a method of claim 8,
charging an electrolyte component into the insulating porous membrane; and
charging a catalyst into each of the two conductive porous membranes.

11. The method according to claim 10,
wherein the adhesive is composed of a thermosetting resin, and
wherein the step of curing the adhesive includes a substep of applying heat.

12. The method according to claim 10,
wherein each of the conductive porous membranes has an air resistance of 10 s/100 mL·645 mm² or less.

13. The method according to claim 11,
wherein each of the conductive porous membranes has an air resistance of 10 s/100 mL·645 mm² or less.
